(19) United States
(12) Patent Application Publication
(10) Pub. No.: US 2008/0291011 A1
(43) Pub. Date: Nov. 27, 2008

(54) Offender alert system

(76) Inventor: JoAnn Frank Knight, San Francisco, CA (US)

Correspondence Address: JoAnn Frank Knight, 219- 6th Street, San Francisco, CA, 94103, US

(21) Appl. No.: 11/802,592

(22) Filed: May 23, 2007

(51) Int. Cl. H04Q 7/00

(52) U.S. Cl. 340/539.13

(57) ABSTRACT

A system is provided to receive, analyze, and forward data from an electronic monitoring bracelet to a monitoring device capable to alert by means of light, sound, or vibration to the presence of a court mandated electronic bracelet worn by a convicted offender, especially a sexual predator. The system includes an electronic bracelet which emits a Radio Frequency signal or a Global Position Signal, a monitor to receive the GPS or RFM signal and to alert the user of the system to the presence of a braceleted offender in order to avoid contact with the offender. The system provides for a forwarding of the alert to persons, private or public, to aid in avoiding offender contact.

### FIELD OF INVENTION

The present invention relates to a practical system to alert the user to the near-by presence of a convicted offender wearing a court-ordered electronic monitoring device which uses Global Positioning Systems or Radio Frequency Monitoring to track the offender.

1. Field of Search

| | | |
|---|---|---|
| 340/539 | and | 455/456.3 |
| References Cited | | |
| AP No. | Rathus | et al |
| 2006 0109 083 | | May, 2006 |
| 2006 006 3540 | Beuch | March, 2006 |
| Pat No. | | |
| 5 661 458 | Page | August 1997 |
| 5 396 227 | Carrol | March 1997 |
| 5 266 944 | Carrol | November 1993 |

2. Prior Art

The field of electronic monitoring using Global Positioning Signals (GPS) and Radio Frequency Monitoring (RFM) is currently used to gather and to store data by agencies in order to carry out court mandated tracking of offender. The court orders the offenders to wear an electronic monitoring device (electronic bracelet) which emits a GPS or RFM signal.

The GPS or RFM provides the agency with information to be used to notify the court appointed officials of any non-compliance by the offender.

The general public is unaware of where an offender is or has been; thus, the electronic monitoring bracelet is of benefit only to the court at some point to prove non-compliance with the court's orders. Currently, there exists no way to use the signal from an electronic bracelet to prevent a crime.

My present invention provides a system using GPS and RFM signals in such a way that a private person could receive notice of the near-by presence of an electronic bracelet (and thus, to the near-by presence of the convicted offender wearing the bracelet). The FCC has designated specific radio frequencies to be used by electronic monitoring bracelets for sexual predators. It is known that sexual predators frequently re-offend which is the reason they are monitored in the first place. However, the current monitoring system is of no help to the public to self determine if a potential threat exists to them personally.

The signal from electronic bracelets is, to date, only of value to agencies to report non-compliance to a legal official. These GPS and RFM signals need to be used to prevent crimes.

Some attempts have been made to utilize the electronic signals of GPS and RFM in unique ways but not in the manner of the present invention.

For instance:

Carroll's U.S. Pat. No. 5,266,944 provides for an electronic system to monitor an abuser for compliance with a protective order of the court. Carrol's system tracks an offender to be sure he is at his proper known location such as home or employment. The whole purpose of U.S. Pat. No. 5,266,944 is to gather information for evidence of a protective order violation. In contrast, my present invention is to provide information that the electronic monitoring signal, and thus the offender, is near-by regardless of whether or not there is a violation of a court order perimeter. Further, Carrol's invention sends a signal to an unknown impersonal monitoring agency incapable of alerting the general public or any individual of the offender's non-compliance to a court order. Carrol's system does not provide a positive, pro-active opportunity for the public or a private individual to determine in real time if the offender is near-by and possibly a threat.

In Carrol's second U.S. Pat. No. 5,396,227 the objective is to provide “a unique signal to a receiving victim's monitoring unit from an abuser's unit in order to warn a known victim of the presence of a know abuser.” Carrol's device protects one person from another when both are known to each other and the court. It is, therefore, a private warning system. In contrast, my invention is to warn the public, both corporate and individual, about an individual known to be a convicted, braceleted offender. My system uses the signal from the electronic bracelet in a unique way to provide the public with information about the near presence of the offender in order to avoid contact with that the offender in order to avoid contact with that offender before a crime can take place. Carrol's device is of benefit only to the court and a known victim. Carrol's device may protect against contact between the abuser and the known victim but it does not provide any opportunity for anyone else to avoid contact with a monitored individual.

Page's system U.S. Pat. No. 5,661,458 provides for an electronic house arrest monitoring system to verify that the monitored individual is in a location at a prescribed reporting time. Page's system is only useful to prove a fact for the purposes of the court. Page's system offers no consideration for the problem arising when the individual violates his court-appointed perimeter. If the violator is a pedophile Page's system would only indicate where the offender is not located. Even if Page's monitoring system provided for consistent tracking the information gleaned would be of no personal value in real time to potential victims of the offender. The offender would be free to roam in public and possibly commit a crime against an individual until such time as the tracking agency was able to locate the offender.

In direct contrast, my alert system of the present invention gives a real time signal to the user of my system in order to avoid contact with the offender whether or not an agency of the court is involved.

Rathus et al system U.S. Pat. Application No. 20060109083 is related to a field of access to electronic data available between consenting individuals who would like to share information between themselves. As such, Rathus et al system would only benefit pedophiles or sex offenders who would like to knowingly contact others of like mind. In direct contrast, my alert system provides real time information to the public corporate or individual, about the presence of an offender wearing a court mandated electronic bracelet when the offender is in the presence of someone who does not want to establish contact with the offender. My system is a warning system not an invitational system Finally, Beuch U.S. Pat. Application No. 20060063540 provides for a new method, network and device to locate an object. Beuch mentions the need to track sex offenders and provides an entirely new wireless method to accomplish this goal. Beuch's patent is in the field of wireless technology. My present invention is not a new wireless network or technology requiring a new device to receive the gathered data. Rather, my present alert system utilizes GPS and RFM technology, in a way not obvious to one skilled in the art of electronic monitoring. If my present invention had been obvious to one skilled in the art of electronic monitoring, Beuch would not have needed to invent a new method, network and device to track a sex offender. Therefore, the method, network and device of Beuch should not impact against my present invention for an alert system. My offender's alert system provided for the use of known components arranged in a unique way to achieve the goal of warning about an offender's electronic bracelet signal and thus warning about the offender.

Beuch's invention is not the same as my invention. Beuch's invention requires a whole new technology in order to provide information to track a sex offender and to warn another person of the offender. In direct contrast, my invention uses know and available technology in a unique arrangement in order to alert to the presence of an offender so that such an offender can be avoided and a potential threat or even a crime could be avoided.

### BACKGROUND OF THE INVENTION

This invention is a continuation of my disclosure document #578666 filed May 26, 2005.

Recent years of high profile child molestation and even murder by repeat offending pedophiles or sexual offenders has led to outrage from all corners of society. Many states are considering mandatory use of an electronic bracelet for all convicted pedophiles before their release back to the community. Currently, some convicted pedophiles are required to wear a monitoring bracelet which emits a signal, either radio frequency or global positioning signal. This signal is received by a monitoring unit operated by the electronic bracelet issuing agency. The agency can know where the offender is at any given moment but cannot possibly know if the offender is in a place where a crime of opportunity could be committed. Only after a crime is committed could any relevant stored data be evaluated by a legal authority. This is a kin to shutting the barn door after the horse is out.

The public needs a monitoring system that any individual could use to alert them to the near-by presence of an offender wearing an electronic monitoring bracelet. Day care centers, schools, recreation centers, children's wards in hospitals, indeed any place where children are know to congregate needs a receiving monitor to alert staff that a pedophile wearing an electronic monitoring bracelet is in close proximity. Most states have laws that a convicted sexual offender may not be within 200 feet of a know children's area. Therefore, any braceleted individual who violates that perimeter is subject to suspicion.

Family homes and individuals need to know when a braceleted pedophile or sexual offender is near-by so that contact with the offender can be avoided.

The present invention meets these needs. Once alert monitoring system is available the public can demand its use. Legislators will be able to pass laws that require electronic bracelets for sexual offenders knowing that the bracelet and the alert monitoring system is a truly effective deterrent to a repeat crime especially against children.

### SUMMARY OF THE INVENTION

The present invention is a system using available components in a unique way in order to help the general public to know in real time that a sexual offender wearing a court mandated electronic monitoring bracelet is near by. The user of my alert monitoring system would be able to take immediate action to avoid contact with the sexual predator.

My alert monitoring system is able to detect the signal from an electronic bracelet, to alert the user of the system via light, sound, or vibration to the near-by presence of the braceleted offender, and to forward the alert to a cell phone, land phone, computer, or agency to help with appropriate action deemed necessary based on the perceived threat the predator poses.

The present invention can store data from the electronic bracelet signal so that such data could be used to identify the offender in order to prove repeat contact with the alert unit, or non-compliance with a court ordered perimeter.

The main goal of the invention is to alert the user to the presence of a braceleted offender in order to avoid contact with the offender and thus avoid a potential crime against the user of my alert system.

In a further application of this invention alcohol monitoring bracelets (currently mandated by the court to monitor blood alcohol levels) could be designed to emit GPS or RFM signals. My alert system monitor would be placed in bars or liquor stores where alcoholic offenders are prohibited to be by the court.

There is increasing awareness of the liability of bars and liquor stores who sell to grossly offending alcoholics. My alert system would allow the public to participate in court ordered ban against the sale of alcohol to braceleted alcohol offenders.

### BRIEF DESCRIPTION OF THE DRAWINGS

FIG. 1 is a top perspective of the system which consists of::

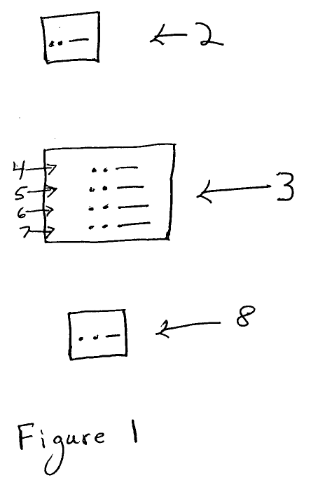

2 electronic monitoring bracelet emitting GPS or RFM signal

3 alert monitor

4 GPS or RFM signal receiving, analyzing and data storage component

5 light, sound or vibration component

6. signal forwarding component

7. tamper proof component

8. compatible alert signal receiving devices

### DETAILED DESCRIPTION OF THE INVENTION AND PREFERRED EMBODIMENT

Referring to the figures

The present invention is a system, designed to alert the user to the near-by presence of an offender, especially a sexual offender, who is wearing a court mandated electronic monitoring bracelet. The electronic bracelet 2 uses Radio Frequency Monitoring (RFM) or Global Position Signal (GPS) to identify the offender and his position.

Referring to the figures

The preferred embodiment of the offender alert system is comprised of

an electronic monitoring device 2 commonly referred to as an electronic bracelet 2 which emits a GPS or RFM signal. This signal is received by the alert monitor 3. The alert monitor 3 is able to receive, analyze and store data from the electronic bracelet 2. The signal receiving component 4 activates the light, sound or vibration components 5 of the alert monitor 3 in order to warn the user of the alert monitor 3 that contact has been detected with an offender's electronic bracelet 2. The user of the alert monitor 3 is able to take action to avoid the offender based on the user's perception of threat posed by the offender.

The light, sound, or vibration component 5 is able to warn the user of the monitor that an offender is near-by based on the signal from the monitor's 3 signal receiving and analyzing component 4. The signal receiving component 4 is programmable so that the user can be alerted about the electronic bracelets 2 proximity to the alert monitor 3 in order to help the user of the alert monitor 3 to make informed decisions to avoid the offender. Knowing the proximity of the electronic bracelet 2 to the alert monitor 3 enables the user of the monitor 3 to gauge potential threat. The light sound and vibration component 5 is programmable to interpret the information from the signal receiving component 4 and register alerts in light or sound or vibration from selected intensities designed to warn from caution to high level of threat.

The alert monitor 3 has a signal forwarding components able to contact any compatible devices such as a computer, cell phone, a land line phone, and agency or 911 either manually by the user or automatically depending on the programs chosen by the user. Compatible devices will enable more people to analyze the electronic bracelet signal 2 and analyze the perceived threat in order to take appropriate action.

The alert monitor 3 has a tamper proof component 7 in order to immediately forward to any compatible device 8 information concerning the tamper.

The alert monitor 3 can be mounted indoors or outdoors to detect the GPS or RFM signal from an electronic bracelet 2. A series of alert monitors 3 can be placed around large areas of property, so that each alert monitor 3 has a unique pattern in its light, sound, or vibrating component 5 to aid the user in identifying which alert monitor 3 is warning about the presence of an electronic bracelet 2 and thus warning about the presence of a convicted offender.

The alert monitor 3 can be made small enough to be carried by the user, or to be worn as jewelry such as a necklace, or wristband, or belt.

In practical use the offender alert system will give the user of the system warning about the near presence of an offender's electronic bracelet 2. The alert monitor 3 will receive the bracelet signal 2 and forward the signal to compatible devices 8 in order to avoid contact with a known offender.

I claim:

1. A system to alert to the presence of braceleted offender comprising:
(a) an electronic monitoring bracelet
(b) an alert monitor with a component to receive and forward Radio Frequency and Global Position Signals; a component to analyze and store data; a component to alert by light, sound or vibration; a component to prevent tampering; a component to warn if tampering has occurred, and
(c) compatible devices such as phones or computers to receive forwarded signals and messages from the alert monitor,

2. A monitoring device to receive a signal from an electronic monitoring bracelet
said signal may be an analog signal, digital signal, Global Positioning Signal or a Radio Frequency Signal
said monitoring device able to alert by light, sound, vibrating, or any combination thereof, that an electronic bracelet signal has been received

3. A monitoring device to receive a signal from an electronic monitoring device such as a micro-chip implanted in a person.
said monitoring may be analog, digital, Global Positioning or Radio Frequency
said monitoring device able to alert by light, sound, vibration, or any combination thereof, that a signal has been received
